(19) United States
(12) Patent Application Publication
(10) Pub. No.: US 2004/0071341 A1
(43) Pub. Date: Apr. 15, 2004

(54) Method for classifying a colour image as to whether it is an exterior or an interior shot

(76) Inventors: Walid Mahdi, Lyon (FR); Mohsen Ardebilian, Lyon (FR); Liming Chen, Lyon (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/432,622

(22) PCT Filed: Dec. 7, 2001
(86) PCT No.: PCT/FR01/03869

(30) Foreign Application Priority Data
Dec. 7, 2000 (FR) 00/15933

(51) Int. Cl. G06T 7/00; G06K 9/34

(52) U.S. Cl. 382/164; 345/723; 382/165

(57) ABSTRACT

Classification process for a colour image with a view to determining the shot location, i.e. exterior or interior, consisting in particular of the following:

determining spectral bands of reference colours Bᵢ corresponding to different image temperature values allowing for the characterisation of an exterior image or an interior image,

selecting a colour image to be analysed,

digitising the selected colour image so that it can be defined in a given colour area (for example RGB),

determining at least for the spectral bands of the reference colours the distribution of colour spectrums of at least part of the digitised colour image,

and analysing the colour spectrums of the digitised image in order to determine the temperature of the image corresponding to an interior image or an exterior image depending on their distribution according to the spectral bands of reference colours.

The subject of this invention relates to the technical aspect of an image in general terms and concerns more specifically the classification of colour images according to the shot location of the image, i.e. exterior or interior.

The subject of this invention can be applied in a particularly advantageous, but non-limitative, manner to the macro-segmentation of video images.

In the technical field referred to above, the aim of the macro-segmentation of a video is to classify shots as semantic units or scenes. This macro-segmentation of the video into shots is based on the analysis of a signal obtained from successive video images. An image reflecting the content of a shot is then chosen as being the representative image of the latter. The classification of shots according to their location makes it easier to segment a video into scenes. The term interior is actually an indication of the location, which is fixed in the initial stage when the scenario is written just before the description of the scenes. This term is the opposite to the term exterior. This indication of location thus enables the technical team to identify in advance all the scenes which have to be filmed in interior or exterior locations. The appropriate use of this term also assists the director of photography in his work as it allows him to identify the scenes which require different lighting and to adapt the lighting accordingly depending on the location of the scene, i.e. exterior or interior. It is also important to be aware of this location index when the video images are analysed since that it is a semantic index.

It is therefore necessary to be able to classify a colour image according to whether the shot was taken in an exterior location, generally in natural surroundings, or in an interior location, for example in a room, a building or a cave.

The subject of the invention is therefore intended to fulfil this requirement by proposing a process which classifies a colour image with a view to determining the location in which the image shot was taken, i.e. exterior or interior.

In accordance with the invention, the process according to the invention consists of:

determining spectral bands of reference colours corresponding to different image temperature values allowing for the characterisation of an exterior image or an interior image,

selecting a colour image to be analysed,

digitising the selected colour image so that it can be defined in a given colour area (for example RGB),

determining at least for the spectral bands of the reference colours the distribution of colour spectrums of at least part of the digitised colour image,

and analysing the colour spectrums of the digitised image in order to determine the temperature of the image corresponding to an interior image or an exterior image depending on their distribution according to the spectral bands of reference colours.

According to a further advantageous application feature, the process according to the invention consists of determining the spectral bands in red, yellow and green arranged by temperature in ascending order as spectral bands of reference colours.

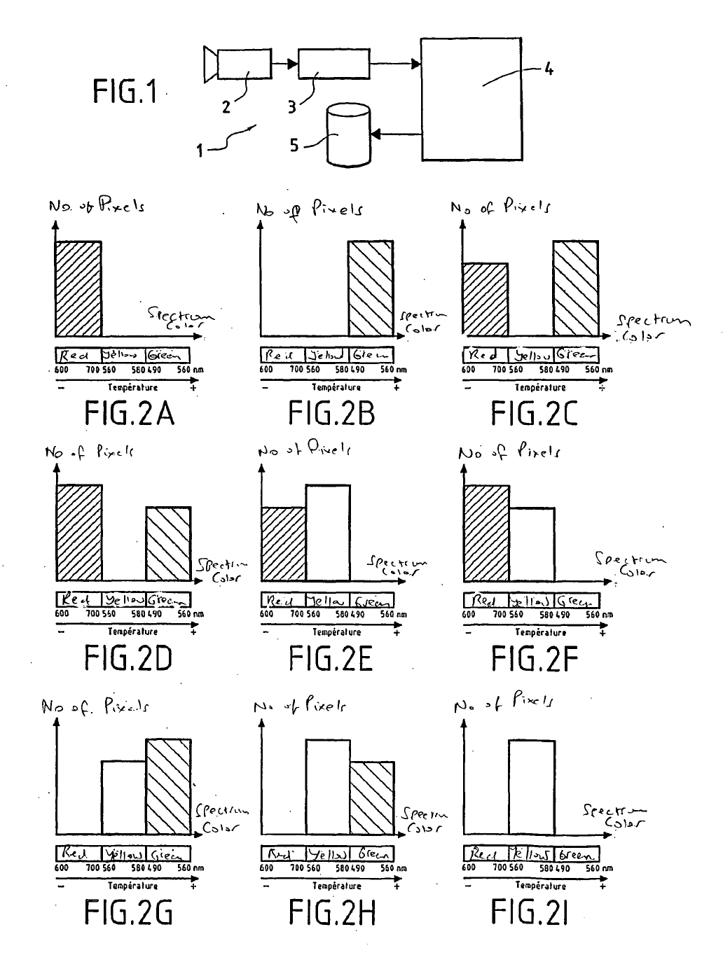

FIG. 1 is a functional diagram of the system allowing for the implementation of a process according to the invention.

FIGS. 2a to 2i are different histograms of spectrums which explain the process according to the invention.

As highlighted in particular in FIG. 1, the subject of the invention concerns a system 1 which is used to classify a colour image according to the location in which the image was shot, i.e. exterior (in natural surroundings) or interior (a room, a building or a cave for example).

In the example illustrated, the system 1 comprises an image sensor 2 as in a video camera, for example, whose output is linked to a digitisation medium 3 used to digitise the images which are defined in a given colour spectral area, for example RGB, which has been identified and defined by the ICI (International Commission on Illumination).

The output of the digitisation medium 3 is connected to a data processing system 4 such as a computer containing programmed resources which are capable of analysing the images in order to determine the location in which the shot was taken for each selected image. The data processing system 4 is connected to storage resources 5 which record each analysed image and the associated location indication index for each one to indicate whether the image was taken in an interior or exterior location.

The system 4 comprises resources which are able to determine spectral bands of the reference colour Bᵢ corresponding to different image temperature values allowing for the characterisation of an exterior image or an interior image. The thermodynamic temperature of a light source may be estimated by analysing the spectral distribution M_{f} of the rays and by classifying the colour associated with the latter.

A spectral distribution M_{f} of a ray is presented according to seven spectral bands as illustrated in table 1 below:

| Bᵢ: Colour | Wavelength | Temperature |
|---|---|---|
| Violet | 380-450 nm | + |
| Blue | 450-480 nm | |
| Cyan | 480-490 nm | |
| Green | 490-560 nm | |
| Yellow | 560-580 nm | |
| Orange | 580-600 nm | |
| Red | 600-700 nm | − |

The different spectral bands are arranged by temperature in descending order. It should be taken into account that artificial light, in contrast to natural light, possesses a spectrum whose values are mainly in the red spectral band and to a lesser extent in the green and blue spectral bands. Therefore, an image whose spectrum is mainly red whose temperature is considered to be the coolest corresponds to interior lighting (for example, the temperature of the interior colours of a room, a building, a cave, etc.). In this case, the image is classified as an interior image, in other words an image whose shot has been taken inside a building, etc.

Conversely, an image whose spectrum is mainly green whose temperature is considered to be the hottest (for example, the temperature of the colour of the sky, the colour of the sea, etc.) corresponds to exterior lighting. In this case, the image is classified as an exterior image, in other words an image whose shot has been taken in natural surroundings.

According to a preferred application feature, we have decided to take red, yellow and green spectral bands into account arranged by temperature in ascending order as reference colour spectral bands. It may be considered that the blue spectral band is difficult to quantify in certain cases in a light spectrum. It has been noted that cinema producers tend to compensate for the excess in the blue spectrum so that its analysis may misrepresent the results. In addition, the yellow spectral band is easy to quantify since it is present in nearly all spectrums. Even though its degree of presence in a spectrum depends on the type of light (natural or artificial), in most cases it is significant enough to be quantified.

The data processing system 4 also comprises resources which are capable of determining the distribution of colour spectrums of at least part of the digitised colour image selected for analysis at least for the spectral bands in the reference colour.

According to a preferred application feature, we intend to select a specific region of the image comprising a maximum amount of information relating to the temperature.

According to this preferred application variant, the digitised colour image defined in the given RGB colour area is transformed into an image in the YIQ colour area which has been identified in its own right and defined by the NTSC (National Television System Committee). It should be pointed out that, in the YIQ system, the three colour components are respectively; Luminance, In phase and Quatrature phase which represent the three axes (white-black), (red-cyan) and (magenta-green) in the colour area. The transformation of the RGB spectral area into the YIQ spectral area is presented in table 2 below:

| STAGE | COLOUR SYSTEM | DESCRIPTION |
|---|---|---|
| 0 | I.C.I. The primary | Primary monochromatic sources P₁ |
| | spectral system R, G, B | red = 700 nm, P₂, green = 546.1 nm, P₃, |
| | | blue = 435.8 nm |

| | | | | | | |
|---|---|---|---|---|---|---|
| 1 | I.C.I. system X, Y, Z | X | 0.490 | 0.310 | 0.200 | R |
| | | Y = | 0.177 | 0.813 | 0.011 | G |
| | | Z | 0.000 | 0.010 | 0.990 | B |
| 2 | NTSC system of | R_{N} | 1.910 | −0.533 | −0.288 | X |
| | primary receptors | G_{N} = | −0.985 | 2.000 | −0.028 | Y |
| | R_{N}, G_{N}, B_{N} | B_{N} | 0.058 | −0.118 | 0.896 | Z |

| | | | |
|---|---|---|---|
| 3 | Y− = | 0.299 R_{N} + 0.587 G_{N} + 0.114 B_{N} | \| |
| | I = | 0.596 R_{N} − 0.274 G_{N} − 0.322 B_{N} | |
| | Q = | 0.058 R_{N} − 0.523 G_{N} + 0.312 B_{N} | |

The image which is chosen and transformed in the YIQ colour area is divided into basic pixel blocks. For example, each basic block may contain 16 sets of 16 pixels. For each basic block of pixels, the average luminance Y and the average in phase I are calculated. It should be pointed out that the originality of the axis I in the YIQ system lies in the fact that it represents the axis (red-cyan) of the colour area whilst the Y axis represents the luminance according to the axis (white-black).

The sum of the average luminance Y and the average in phase I is then calculated for each basic block of pixels. The block of pixels with the maximum sum of the average luminance Y and the average in phase I is selected as it represents the area of the image which contains the most information relating to temperature. The maximum luminance Y and phase I values in the image correspond to the area of the image with the highest temperature associated with the light source.

The process then consists of studying the temperature for the selected block of pixels. The distribution of the colour spectrums M_{f} is determined for this purpose for the selected block of pixels using the formula below:

M_{f}=Mᵣro+Mᵥvo+M_{b}bo,

where Mᵣ, Mᵥ, M_{b} correspond to the pixel matrix of the part of the image of the component, respectively red (R), green (G) et blue (B), and ro=700, vo=546.1 and bo=435.8.

The spectral distribution M_{f} obtained using the formula above is described according to the seven visible spectral bands presented in table 1. In order to assist the process of classifying and quantifying the different visible spectral bands of the matrix M_{f}, an amplified version A_{f} of the matrix M_{f} is used based on the following formula:

$${A}_{f} ( i , j ) = \begin{matrix}380 & if & 380 & \leq & {M}_{f} ( i , j ) & \leq & 450 \\ 450 & if & 450 & < & {M}_{f} ( i , j ) & \leq & 480 \\ 480 & if & 480 & < & {M}_{f} ( i , j ) & \leq & 490 \\ 490 & if & 490 & < & {M}_{f} ( i , j ) & \leq & 560 \\ 560 & if & 560 & < & {M}_{f} ( i , j ) & \leq & 580 \\ 580 & if & 580 & < & {M}_{f} ( i , j ) & \leq & 600 \\ 600 & if & 600 & < & {M}_{f} ( i , j ) & \leq & 700\end{matrix}$$

where i, j, correspond to the number of pixels in the matrix of the part of the image.

The process then consists of applying to the amplified matrix A_{f} a quantification and classification process which focuses on the three reference spectral bands as explained above, namely the colour spectrums of red (A_{f}(i,j)=600), yellow (A_{f}(i,j))=560) and green (A_{f}(i,j)=490).

It should be pointed out that the colour spectrums of violet, cyan and orange are ignored whereas the blue spectrums are replaced by yellow spectrums. The histogram of the spectrum is calculated on the basis of the selected block of pixels according to the three reference colour spectral bands, namely red, yellow and green as defined above.

The process then consists of detecting the two dominant spectral bands which correspond to the two highest peaks in the spectrum histogram. By comparing the values of these peaks and their position with the temperature axis, it is possible to determine whether the components in the spectrum of the selected block of pixels tend to be closer to the warm spectrums or, on the contrary, closer to the cooler spectrums. It is then possible to classify the image as an interior image or an exterior image.

Therefore, depending on whether the temperature of the spectrum is warm or cold, it is possible to classify an image as an interior image or an exterior image.

FIGS. 2a to 2i illustrate the different scenarios which are likely to occur in the determination of the two dominant spectrums of the histogram of an image spectrum.

FIG. 2a illustrates the case of a completely cold spectrum, where the image is classified as an interior image, whilst FIG. 2b corresponds to a completely warm spectrum representing an image classified as an exterior image. In the former case, the spectrum is created entirely in the red spectral band (cold temperature) and in the latter case the spectrum is created entirely in the green spectral band (warm temperature).

FIG. 2c illustrates the case of a mainly green spectrum, as the green spectral band is larger than the red one. Therefore, the corresponding image is classified as an exterior image as the temperature of the light is warm.

FIG. 2d illustrates the case of a mainly red spectrum, as the red spectral band is larger than the green one. The corresponding light is cool and the associated image is classified as an interior image.

In the case of FIG. 2e, the two peaks of colour, yellow and red, are positioned in line with the warm temperature as the yellow peak is higher than the red one. The associated image is therefore classified as an exterior image.

By analogy, in the case of FIG. 2f, an image giving a red peak which is higher than the yellow one corresponds to an image classified as an interior image.

FIG. 2g illustrates the case in which the green peak is higher than the yellow one. The associated light is therefore located in line with the warm temperature and the corresponding image is classified as an exterior image.

Similarly, FIG. 2h illustrates the case in which the yellow peak is higher than the green one. In this case, the image is classified as an interior image.

FIG. 2i corresponds to a spectrum which is created entirely in the yellow spectral band. This type of spectrum generally stems from an image with back lighting. In this case, the determination of the spectral distribution matrix reveals a dominance of yellow light in the block which is identified as belonging to an intense light source (the sky or the midday sun) which is visible from a window, for example. Therefore, the intensity of the white indicates whether the image creates the effect of back lighting or of an exterior image. This effect is identified by analysing the histogram in terms of the grey levels of the entire image. By analysing the histogram in terms of the grey levels, it is possible to classify the image as an exterior image or an interior image according to the pixels in the white and dark areas respectively. An accumulation of a large number of pixels in the intense, white areas indicates that the image is an exterior image. In the opposite case, the image is classified as an interior image.

The subject of the invention thus relates to a process used to classify a colour image according to the thermodynamic temperature of the light source existing when the image was shot. By taking into account this temperature, which is estimated by analysing the spectral distribution of the rays, it is possible to classify the image as an interior or exterior image according to the shot location.

1- Classification process for a colour image with a view to determining the shot location, i.e. exterior or interior, consisting in particular of the following:
determining spectral bands of reference colours Bᵢ corresponding to different image temperature values allowing for the characterisation of an exterior image or an interior image,
selecting a colour image to be analysed,
digitising the selected colour image so that it can be defined in a given colour area (for example RGB),
determining at least for the spectral bands of the reference colours the distribution of colour spectrums of at least part of the digitised colour image,
and analysing the colour spectrums of the digitised image in order to determine the temperature of the image corresponding to an interior image or an exterior image depending on their distribution according to the spectral bands of reference colours.

2- Process according to claim 1 consisting in particular of the determination of spectral bands in red, yellow and green arranged by temperature in ascending order as spectral bands of reference colours.

3- Process according to claim 1 consisting in particular, for the selection of part of the digitised colour image, of:
transforming the digitised colour image defined in a given colour area (for example (RGB) into an image in the YIQ colour area,
dividing the image in the YIQ colour area into basic blocks of pixels,
calculating the average luminance Y and the average in phase I for each basic block of pixels,
selecting the block of pixels with the maximum sum of the average luminance Y and the average in phase I,
and determining the distribution of the colour spectrums for the selected block of pixels corresponding to the part of the colour image.

4- Process according to claim 1 or 3 consisting in particular of determining the distribution of the colour spectrums M_{f} of part of the colour image by using the formula below:
M_{f}=Mᵣro+Mᵥvo+M_{b}bo,
where M_{f}, Mᵥ, M_{b} correspond to the pixel matrix of the part of the image of the component, respectively red (R), green (G) and blue (B), and ro=700, vo=546,1 and bo=435,8.

5- Process according to claim 4 consisting in particular of calculating an amplified version A_{f} of the distribution of colour spectrums M_{f}, based on the following formula:
$${A}_{f} ( i , j ) = \begin{matrix}380 & if & 380 & \leq & {M}_{f} ( i , j ) & \leq & 450 \\ 450 & if & 450 & < & {M}_{f} ( i , j ) & \leq & 480 \\ 480 & if & 480 & < & {M}_{f} ( i , j ) & \leq & 490 \\ 490 & if & 490 & < & {M}_{f} ( i , j ) & \leq & 560 \\ 560 & if & 560 & < & {M}_{f} ( i , j ) & \leq & 580 \\ 580 & if & 580 & < & {M}_{f} ( i , j ) & \leq & 600 \\ 600 & if & 600 & < & {M}_{f} ( i , j ) & \leq & 700\end{matrix}$$
where i, j, correspond to the number of pixels in the matrix of the part of the image.

6- Process according to claim 5 consisting in particular of determining the histogram of the colour spectrum of the part of the image for the colour spectrums of red (A_{f}(i,j)=600), yellow (A_{f}(i,j))=560) and green (A_{f}(i,j)=490) on the basis of the amplified version A_{f}.

7- Process according to claim 6 consisting in particular of determining the two peaks in the colour spectrums relating to the red, yellow and green colour bands.

8- Process according to claims 1 and 7 consisting in particular of analysing the two peaks in the colour spectrums in the red, yellow and green colour bands in order to determine the temperature of the image and, by extension, whether it corresponds to an interior image or an exterior image.

9- Process according to claim 8 consisting in particular of classifying an image respectively as an interior image or an exterior image in the case of a single peak corresponding to 100% of the green or red spectral band.

10- Process according to claim 8 consisting in particular of classifying an image respectively as an interior image or an exterior image in the case of a peak in the red band with a higher or lower value than the peak in the green band.

11- Process according to claim 8 consisting in particular of classifying an image respectively as an interior image or an exterior image in the case of a peak in the red band with a higher or lower value than the peak in the yellow band.

12- Process according to claim 8 consisting in particular of classifying an image respectively as an interior image or an exterior image in the case of a peak in the yellow band with a higher or lower value than the peak in the green band.

13- Process according to claim 8 consisting in particular, in the case of a single peak corresponding to the entire yellow spectral band, of transforming the image into grey levels and analysing the histogram on the basis of the grey levels in order to classify the image as an exterior image or interior image respectively depending on the number of pixels in the white or dark colour areas.
